(19) United States
(12) Patent Application Publication
(10) Pub. No.: US 2010/0305805 A1
(43) Pub. Date: Dec. 2, 2010

(54) Vehicle status monitoring apparatus

(75) Inventor: Kazuhi Yamaguchi, Kobe-shi (JP)

Correspondence Address: OLIFF & BERRIDGE, PLC, P.O. BOX 320850, ALEXANDRIA, VA, 22320-4850, US

(73) Assignee: FUJITSU TEN LIMITED, KOBE-SHI (JP)

(21) Appl. No.: 12/801,019

(22) Filed: May 17, 2010

(30) Foreign Application Priority Data
Jun. 1, 2009 (JP) 2009-132181

(51) Int. Cl. G06F 7/00

(52) U.S. Cl. 701/29

(57) ABSTRACT

A vehicle status monitoring apparatus monitors a vehicle status in which it is possible to control an engine to stop the engine in a case where the vehicle status satisfies first conditions and a user operation satisfies second conditions. The vehicle status monitoring apparatus calculates level information indicative of an amount of occurrence of a state in which the user operation does not satisfy the second conditions while the vehicle status satisfies the first conditions. A user is informed of the calculated level information.

### BACKGROUND OF THE INVENTION

1. Field of the Invention

The invention relates to a technology of monitoring a status of a vehicle.

2. Description of the Background Art

Recently, for the purpose of improving fuel efficiency and reducing exhaust emission, control systems that control a vehicle, such as one that automatically stops the engine of the vehicle (e.g. an idling stop) and one that controls the vehicle so that a driver can drive the vehicle economically (hereinafter referred to as eco-run) to reduce fuel consumption or the like, are widely known.

The term “eco” hereinafter means economy, ecology or both of them. Moreover, the term “economy” hereinafter means saving fuel by controlling fuel consumption. Furthermore, the term “ecology” hereinafter means reducing fossil fuel consumption, or reducing hazardous substances or carbon dioxide generated or emitted as a result of fossil fuel combustion.

For example, JP2007-46546A discloses a conventional control system including a detector that detects a vehicle status and a status of a user (a passenger of the vehicle) operation to the vehicle and a controller that implements eco-run control based on the vehicle status and the user operation detected by the detector. The “eco-run control” includes idling stop control that automatically stops the engine of the vehicle when the control system judges that predetermined conditions for stopping the engine are satisfied, based on the vehicle status and the user operation. The “eco-run control” may further include control that starts the engine when the control system judges that predetermined conditions for restarting the engine are satisfied, based on the vehicle status and the user operation.

In a control system, there is a case where a user operation may prevent the conditions for stopping the engine from being satisfied, and thus interrupt the eco-run control executed by the control system. In this case, the conventional control system does not inform the user of a level that the eco-run control has been interrupted by a user operation. Therefore, the user does not know the level that his/her operations have interrupted the eco-run control and thus cannot improve the level by refraining from operations leading to interruption of the eco-run control or by other methods.

### SUMMARY OF THE INVENTION

According to one aspect of the invention, a vehicle status monitoring apparatus monitors a vehicle status in which it is possible to control an engine to stop the engine in a case where the vehicle status satisfies first conditions and a user operation satisfies second conditions. The vehicle status monitoring apparatus includes: a first judging part that judges whether the vehicle status satisfies the first conditions; a second judging part that judges whether the user operation satisfies the second conditions; a calculation part that calculates level information indicative of an amount of occurrence of a state in which the user operation does not satisfy the second conditions while the vehicle status satisfies the first conditions; and a controller that controls an informing apparatus to inform a user of the level information.

The user is informed of the level information indicative of the amount of occurrence of the state in which the user operation does not satisfy the second conditions while the vehicle status satisfies the first conditions. Therefore, the user can know a level that the user operation interrupts the control that stops the engine and can make an improvement, for example, by refraining from an operation interrupting the control that stops the engine.

According to another aspect of the invention, the controller controls the informing apparatus so that the informing apparatus provides the level information while the vehicle is stopping.

The user is informed of the level information while the vehicle is stopping during which the user can perform an operation by which the second conditions are satisfied. Therefore, immediately after being informed, the user of the vehicle can make an improvement, for example, by refraining from an operation interrupting the control that stops the engine.

According to another aspect of the invention, the controller controls the informing apparatus so that the informing apparatus provides information about a difference between the level information and a target value of the level information.

The user of the vehicle can refrain from an operation interrupting the control that stops the engine in order to reduce the difference between the level information and the target value of the level information.

Therefore, an object of the invention is to provide a technology of informing a user of a level that a control that stops an engine is interrupted.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a configuration of an engine control system;

FIG. 2A shows vehicle requirements and user requirements;

FIG. 2B shows ideal electrical device consumption status;

FIG. 3A shows a hardware configuration of a microcomputer;

FIGS. 3B to 3D show functional configuration of the microcomputer;

FIGS. 4A to 4E show examples displayed by an informing apparatus;

FIG. 5A is a flow chart showing an eco-run control process; and

FIG. 5B is a flow chart showing an informing control process.

### DESCRIPTION OF THE EMBODIMENTS

Hereinbelow, an embodiment of the invention is described with reference to the attached drawings.

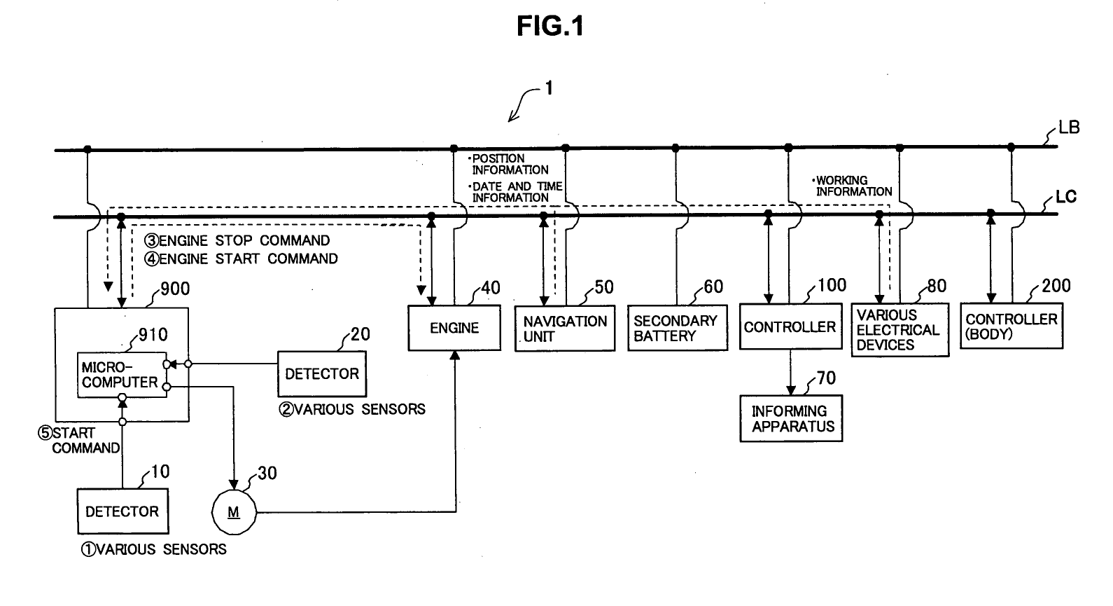

FIG. 1 shows a configuration of an embodiment of an engine control system equipped with a vehicle status monitoring apparatus that monitors a vehicle status.

An engine control system 1 shown in FIG. 1 is installed in a vehicle and controls an engine 40 installed in the vehicle. In this embodiment, examples of the vehicle include a car, a motorized bicycle, a light vehicle, a trolleybus, a military motor vehicle, and a railroad vehicle. Moreover, the engine control system 1 may adopt a configuration not only for a vehicle but also for a ship, an airplane, and a spacecraft including a space station.

The engine control system 1 includes a detector 10, a detector 20, a starting unit 30, the engine 40, a navigation unit 50, a secondary battery 60, an informing apparatus 70, various electrical devices 80, and a controller 100, a controller 200, and a vehicle status monitoring apparatus 900. Each of the units, apparatuses, and devices of the engine control system 1 is supplied with electricity from the secondary battery 60 via a power line LB.

The detector 10 detects a vehicle status and the detector 20 detects a status of a user operation to the vehicle, and the detector 10 and the detector 20 output signals representing the detected statuses to the vehicle status monitoring apparatus 900.

The vehicle status includes a revolving status of the engine 40, a running status of the vehicle, a temperature status of the vehicle, a maintaining status of a braking force that stops the vehicle or reduces a speed of the vehicle, a status of electricity stored in the secondary battery 60, and an abnormal status where an abnormality including a failure occurs to the vehicle. Moreover, the running status of the vehicle is represented by a running speed of the vehicle and acceleration applied to the vehicle. Furthermore, the temperature status of the vehicle is represented by temperatures related to the vehicle. The temperatures related to the vehicle include an air outlet temperature of an air blower of an air conditioner not illustrated in the drawings. The air outlet temperature includes not only a temperature of an air outlet of the air blower but also a room temperature of an area near the air outlet in a cabin. The area near the air outlet is, for example, an area directly affected by air coming from the air outlet.

The status of a user operation to the vehicle includes an operating status of the shift lever, an operating status of the brake, an operating status of the accelerator, an operating status of the clutch, an opening and closing status of a door, an opening and closing status of the hood, an operating status of the air conditioner, an operating status of the navigation unit 50, and an operation status of the various electrical devices 80 of the vehicle. The operating status of the shift lever is represented, for example, by a shift lever position of parking, drive, neutral, or back. Similarly, the operating status of the brake is represented, for example, by whether a brake pedal is pressed and to what level the brake pedal is pressed. The operating status of the accelerator is represented, for example, by whether an accelerator pedal is pressed and to what level the accelerator pedal is pressed. The operating status of the clutch is represented, for example, by whether a clutch pedal is pressed and to what level the clutch pedal is pressed. Moreover, the opening and closing status of a door is represented, for example, by whether a door is opened or closed, and the opening and closing status of the hood is represented, for example, by whether the hood is opened or closed. Furthermore, the operating status of the air conditioner is represented, for example, by presence or absence of operations of turning on the air conditioner and setting a temperature on the air conditioner and an amount of airflow from the air conditioner as well as the set temperature and the set amount of airflow. The operating statuses of the navigation unit 50 and the various electrical devices 80 are represented, for example, by an operation of setting a working condition of each of those electrical devices and the set working condition.

The detector 10 detects one or more vehicle statuses and the detector 20 detects one or more statuses of user operations. For example, the detector 10 includes various sensors such as an engine revolution sensor, a speedometer, a shift lever position sensor, a brake switch, a gravity accelerometer, an accelerator pedal sensor, a temperature sensor, a clutch sensor, a door sensor, a hood sensor, etc. The detector 10 detects revolutions per minute of the engine 40, a vehicle speed, a shift lever position, presence or absence of an operation of braking, an acceleration applied to the vehicle, an accelerator opening angle, temperatures related to the vehicle, pressure applied to the clutch pedal, opening and closing of a door, opening and closing of the hood (hereinafter referred to as RPM and others). The detector 10 also outputs signals representing the detected RPM and others to the vehicle status monitoring apparatus 900.

For example, the detector 20 includes various sensors such as a brake negative pressure sensor and a voltage sensor. The detector 20 detects a brake negative pressure and a battery voltage (hereinafter referred to as voltage and others) and outputs signals representing the detected voltage and others to the vehicle status monitoring apparatus 900.

It is explained in this embodiment that the engine control system 1 includes two sensors of the detector 10 and the detector 20, but the number of sensors is not limited to two and the engine control system 1 may adopt a configuration where one, three, or more sensors detect temperatures and others that the detector 10 and the detector 20 detect.

The starting unit 30 includes, for example, a starter motor. The starting unit 30 starts the engine 40 under the control of the vehicle status monitoring apparatus 900, using electricity supplied by the secondary battery 60.

The engine 40 includes, for example, a gasoline engine or a diesel engine. When receiving an engine start command for starting working from the vehicle status monitoring apparatus 900, the engine 40 starts working activated by the starting unit 30. After that, the engine 40 stops when receiving an engine stop command for stopping working. The engine 40 after starting working, combusts fuel under the control of the vehicle status monitoring apparatus 900 to generate mechanical power used for traveling or others of the vehicle. Moreover, the engine 40 heated by the combustion is cooled down by cooling water. The heat absorbed from the engine 40 is, for example, released to the cabin of the vehicle by the air conditioner not illustrated in drawings.

The navigation unit 50 obtains position information related to a position of the vehicle in which the navigation unit 50 is installed, using GPS (Global Positioning System). The position information includes, for example, information representing a position of the vehicle at latitude and longitude and information related to the road where the vehicle travels. The information related to the road where the vehicle travels includes information about a structure, safety, and traffic of the road where the vehicle travels. The information about the structure of the road includes information showing whether the vehicle needs to go through a tunnel or an underground passage on the road, information showing whether the road is sloped, and information of inclination of the slope. The information related to the safety of the road includes information showing a point of the road or a point in an area near the road, where an accident is occurred more frequently than other points or an average (high accident location). The information about the traffic of the road includes information showing an intersection where time duration of a red light is long and a traffic congestion status of the road.

Moreover, the navigation unit 50 obtains weather information, for example, using a communication line of a mobile phone. The weather information includes information showing weather forecast or observed weather linked to a location of which the weather is forecast.

Furthermore, the navigation unit 50 obtains date and time information, for example, using a system clock. The date and time information includes information representing system time and information representing a season identified based on the system time. The navigation unit 50 transmits the obtained position information related to a position of the vehicle, the obtained date and time information, and the obtained weather information to the vehicle status monitoring apparatus 900.

The secondary battery 60 includes, for example, a lead battery or the like. The secondary battery 60 supplies stored electricity to each of the units, apparatuses and devices of the engine control system 1.

The informing apparatus 70 includes, for example, a display unit or an audio output unit. The display unit includes, for example, a display screen, and the audio output unit includes, for example, a speaker. The informing apparatus 70 provides the following various types of information under the control of the vehicle status monitoring apparatus 900. Concretely, the display unit displays following various types of information and the audio output unit outputs the following various types of information by voice. More concretely, the display unit displays the following level information and the audio output unit outputs the following level information by voice.

Examples of the various electrical devices 80 include an audio unit, an air conditioner, a wiper, a room light, a mirror heater, and a seat heater. The various electrical devices 80 work using electricity supplied by the secondary battery 60 and transmit working information representing working status thereof to the vehicle status monitoring apparatus 900. The working information includes information representing electricity consumption consumed by the working or information representing a degree (in other words, a level) of the electricity consumption.

Each of the controller 100, the controller 200, and the vehicle status monitoring apparatus 900 includes, for example, an ECU (Electronic Control Unit). The controller 100, the controller 200, and the vehicle status monitoring apparatus 900 are communicably connected with each other via a communication line LC including a CAN (Controller Area Network) bus or a LIN (Local Interconnect Network) bus.

The controller 100 includes, for example, a meter ECU. Under the control of the vehicle status monitoring apparatus 900, the controller 100 controls the informing apparatus 70 so that the informing apparatus 70 provides the following various types of information. Concretely, the controller 100 controls the informing apparatus 70 so that the informing apparatus 70 provides the following level information.

The controller 200, for example, includes a body ECU. The controller 200 controls, for example, opening and closing of a door and the hood. The controller 200 may adopt, for example, a configuration where the controller 200 is coupled to a detector, not illustrated in the drawings, that detects presence of a movable body in or around the vehicle or removal of an electrical device installed in or on the vehicle. In this configuration, the controller 200 may adopt a configuration that detects a break-in to the vehicle or an abnormality such as stealing from the vehicle based on a result detected by the detector. Moreover, the controller 200 transmits the detected result of the abnormality to the vehicle status monitoring apparatus 900.

The vehicle status monitoring apparatus 900 is communicably connected not only with the controller 100 and the controller 200 but also with the engine 40, the navigation unit 50, and the various electrical devices 80 via the communication line LC.

The vehicle status monitoring apparatus 900 performs an eco-run control process that is a software process, thereby controlling the vehicle so that the vehicle stops idling according to the temperatures and others detected by the controller 100 and the controller 200. Therefore, the vehicle status monitoring apparatus 900 that stops idling may be referred to as an idling stop controller.

Concretely, in a case where the vehicle status monitoring apparatus 900 judges that predetermined engine stop conditions are satisfied, based on a vehicle status and a status of a user operation detected or obtained by various units coupled to the vehicle status monitoring apparatus 900, the vehicle status monitoring apparatus 900 outputs an engine stop command to the controller 100. The vehicle status monitoring apparatus 900 is coupled to the detector 10, the detector 20, the engine 40, the navigation unit 50, the various electrical devices 80, the controller 100, and the controller 200 which are hereinafter collectively referred to as the detector 10 and others.

A possible concrete example of the engine stop conditions is that the vehicle is in a first status where the vehicle is stopping and, at the same time, in a second status where idling of the vehicle can be stopped. Here, the first status where the vehicle is stopping includes a status where a speed of the vehicle is slower than a predetermined speed for a predetermined time. Moreover, a condition where the vehicle is in the second status where idling can be stopped is categorized into two: one related to a vehicle status (hereinafter referred to as vehicle requirements) for the engine stop conditions and the other related to a status of a user operation (hereinafter referred to as user requirements) for the engine stop conditions. The user requirements are ones that a user can handle, and the vehicle requirements are ones that a user cannot handle. Concretely, for example, the user requirements include a condition where satisfaction of the user requirements depends on a user operation, and concretely, for example, the vehicle requirements include a condition where satisfaction of the vehicle requirements depends on a status of the vehicle. More concretely, for example, the user requirements include a condition which a user can satisfy by performing a predetermined operation, and more concretely, for example, the vehicle requirements include a condition which a user cannot satisfy by performing any operation.

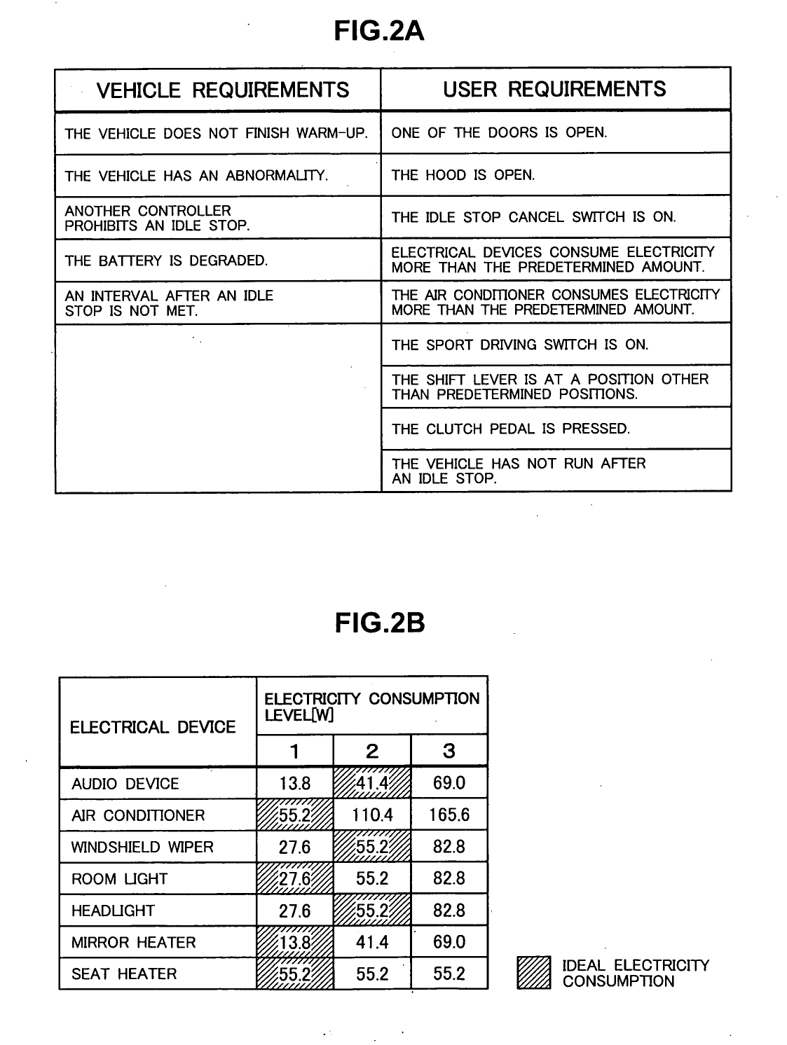

Referring to FIG. 2A, concrete examples of the vehicle requirements and the user requirements are explained. FIG. 2A shows the concrete examples of the vehicle requirements and the user requirements.

As shown in a right column of FIG. 2A, the user requirements are not satisfied in a case where a user does not close a door after opening it (in other words, in a case where a door remains open) or in a case where the hood is open. In the case where the door remains open, for example, the user often intends to drive backward with his/her head putting out of the door.

The user requirements are not also satisfied in a case where the user does not push an idling stop cancel switch back after pushing it down. The idling stop cancel switch inputs a signal that prohibits an idling stop to the vehicle status monitoring apparatus 900 when the idling stop cancel switch is pushed down.

Moreover, the user requirements are not satisfied in a case where the navigation unit 50, the various electrical devices 80 or the air conditioner uses electricity more than a predetermined amount, in order to ensure the electricity that the starting unit 30 uses to restart the engine 40.

Furthermore, the user requirements are not satisfied in a case where the user does not push a sport driving switch back after pushing it down, because the user often intends to start the vehicle. Due to a similar reason, the user requirements are also not satisfied in a case where the user moves the shift lever to a brake range or from a range to another, where the user presses the clutch pedal, or where the user does not start the vehicle after an idling stop.

As shown in a left column of FIG. 2A, in a case where the vehicle does not finish warm-up, the vehicle requirements are not satisfied because the vehicle finishes the warm-up by working of the engine 40.

Moreover, in a case where an abnormal status is detected in or on the vehicle or where the controller 100 or the controller 200 prohibits an idling stop, the vehicle requirements are not satisfied.

Moreover, in a case where the secondary battery 60 is degraded, the vehicle requirements are not satisfied to prevent the starting unit 30 from becoming unable to restart the engine 40.

Furthermore, in a case where an interval after an idling stop is not met, the vehicle requirements are not satisfied. A concrete example of such a case is the one where restart of the engine 40 after an idling stop ensures the idling stops interval required for supplying a brake booster with negative pressure enough to brake the vehicle.

The vehicle status monitoring apparatus 900 may adopt a configuration that judges whether the vehicle is stopping, based on one or more signals representing a RPM of the engine, a vehicle speed, a shift lever position, and presence or absence of an operation of braking, an acceleration applied to the vehicle, and an accelerator opening degree. The vehicle status monitoring apparatus 900 may adopt a configuration that judges that the vehicle is in a status where idling can be stopped in a case where the vehicle status monitoring apparatus 900 judges that enough braking force can be maintained even if idling is stopped, for example, based on signals representing brake negative pressure. In addition to the judgment regarding the braking force, the vehicle status monitoring apparatus 900 may adopt a configuration that judges that idling can be stopped in a case where the secondary battery 60 stores electricity enough for a restart, for example, based on signals representing battery voltage and other information.

The vehicle status monitoring apparatus 900 starts the starting unit 30 and at the same time outputs an engine start command to the controller 100 in a case where the vehicle status monitoring apparatus 900 judges that predetermined engine restart conditions are satisfied.

A possible concrete example of the engine restart conditions is that an operation by a driver of the vehicle to start the engine 40 is detected or an event requiring the engine 40 to restart occurs. Therefore, the vehicle status monitoring apparatus 900 judges whether the driver intends to start the engine, for example, based on one or more changes of a shift lever position, a brake switch signal, and an acceleration signal. Moreover, the vehicle status monitoring apparatus 900 detects, an event, for example, where an engine start decreases or increases the air outlet temperature of the air conditioner at a level that an engine coolant needs to be heated or a refrigerant needs to be cooled, based on the air outlet temperature.

The vehicle status monitoring apparatus 900 includes a microcomputer 910. The microcomputer 910 controls, based on signals output from the detector 10 and other devices, individual devices coupled to the vehicle status monitoring apparatus 900 by performing software process.

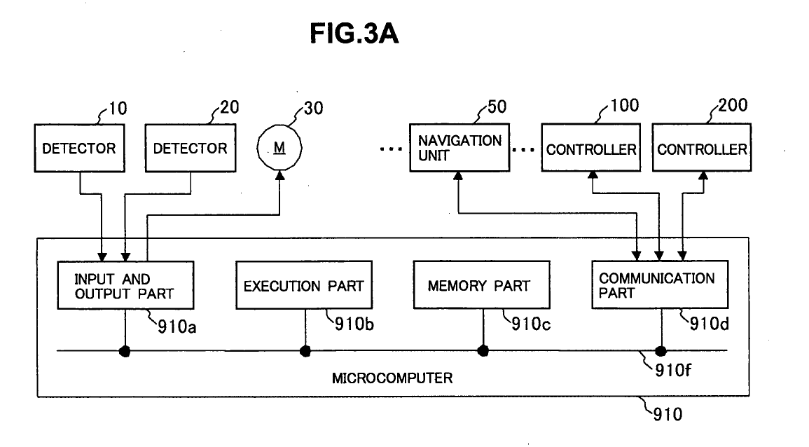

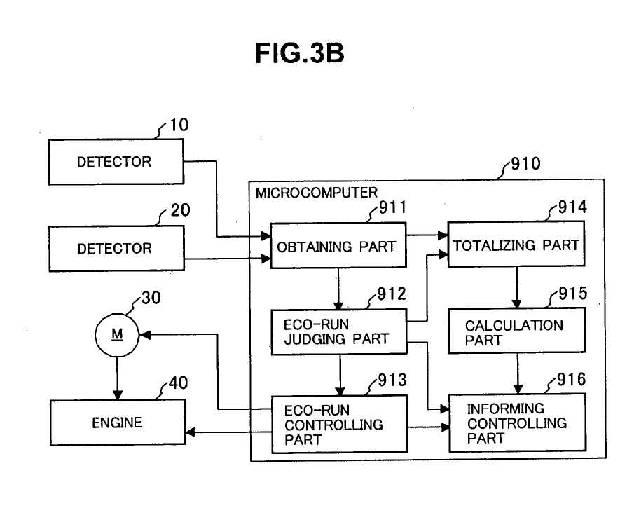

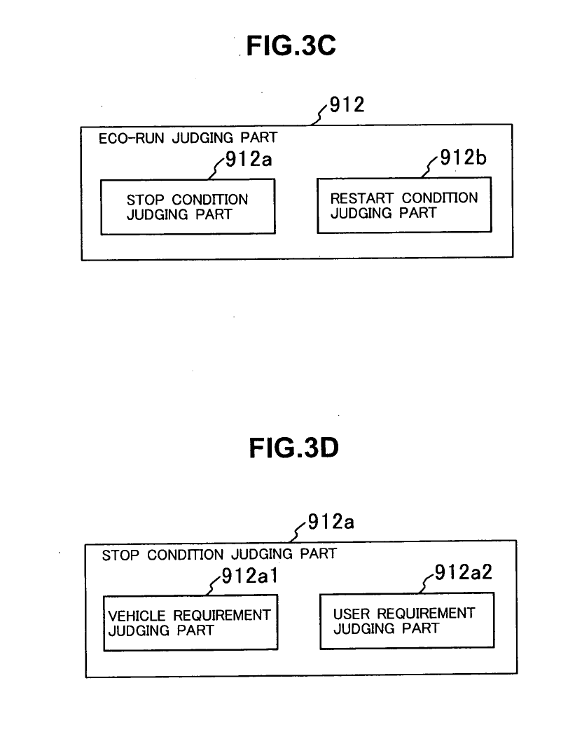

Referring to FIG. 3A, a hardware configuration of the microcomputer 910 is explained. FIG. 3A shows an example hardware configuration of the microcomputer 910.

The microcomputer 910 shown in FIG. 3A includes, for example, an input and output part 910a, an execution part 910b, the memory part 910c and the communication part 910d. the input and output part 910a includes, for example, an analogue-to-digital converter, the execution part 910b includes, for example, CPU (Central Processing Unit), the memory part 910c includes, for example, ROM (Read-Only Memory), and the communication part 910d includes, for example, CAN controller. The input and output part 910a, the execution part 910b, the memory part 910c, and the communication part 910d are coupled with each other so that information can be received and transmitted among them.

Software process is implemented by reading a program stored in the memory part 910c and performing calculations in accordance with an execution order of the software process written in the read program that are performed by the execution part 910b. Information representing a result of the calculation performed by the execution part 910b is written into the memory part 910c. Moreover, if necessary, the input and output part 910a and the communication part 910d input and output information input, output or communicated between or among units, apparatus and devices as information to be calculated by the execution part 910b or information as the result of the calculation.

Next, referring to FIG. 3B, a configuration of the microcomputer 910 is explained focusing on the functions thereof. FIG. 3B is a function block diagram showing an example configuration of the microcomputer 910.

The microcomputer 910 includes an obtaining part 911, an eco-run judging part 912, an eco-run controlling part 913, a totalizing part 914, a calculation part 915, and an informing controlling part 916.

The obtaining part 911 is implemented by an obtaining process performed by the execution part 910b. The obtaining part 911 obtains signals output or transmitted respectively from the detector 10, the detector 20, the engine 40, the navigation unit 50, the various electrical devices 80, the controller 100, and the controller 200. Concretely, the obtaining part 911 obtains signals that allow the obtaining part 911 to judge whether the engine stop conditions or the engine restart conditions are satisfied. More concretely, the obtaining part 911 obtains signals representing a vehicle status and a status of a user operation. In addition, the obtaining part 911 obtains position information, date and time information, weather information, and working information.

The eco-run judging part 912 is implemented by an eco-run judging process performed by the execution part 910b. The eco-run judging part 912 judges whether to command the eco-run controlling part 913 to perform the eco-run control, based on the signals and information obtained by the obtaining part 911.

Concretely, as shown in FIG. 3C, the eco-run judging part 912 includes a stop condition judging part 912a and a restart condition judging part 912b. The stop condition judging part 912a judges whether the engine stop conditions are satisfied, based on the signals and information obtained by the obtaining part 911. Similarly, the restart condition judging part 912b judges whether the engine restart conditions are satisfied, based on the signals and the information obtained by the obtaining part 911.

More concretely, as shown in FIG. 3D, the stop condition judging part 912a includes a vehicle requirement judging part 912a1 and a user requirement judging part 912a2. The vehicle requirement judging part 912a1 judges whether a vehicle status represented by signals and information obtained by the obtaining part 911 satisfies the vehicle requirements of the engine stop conditions. Moreover, the vehicle requirement judging part 912a1 may adopt a configuration that identifies an element of the vehicle status that has prevented the vehicle requirements from being satisfied. Similarly, the user requirement judging part 912a2 judges whether a user operation represented by the signals and information obtained by the obtaining part 911 satisfies the user requirements of the engine stop conditions. Moreover, the user requirement judging part 912a2 may adopt a configuration that identifies a user operation that has prevented the user requirements from being satisfied. The configuration of the restart condition judging part 912b is almost the same as the one of the stop condition judging part 912a and thus the explanation thereof is omitted.

The eco-run controlling part 913 is implemented by an eco-run judging process performed by the execution part 910 bs. The eco-run controlling part 913 performs the eco-run control that controls the starting unit 30 and the engine 40, based on the judgment of the eco-run judging part 912. Concretely, the eco-run controlling part 913 transmits an engine stop command to the engine 40 when the eco-run judging part 912 judges that the engine stop conditions are satisfied. The eco-run controlling part 913 also transmits an engine start command to the starting unit 30 and the engine 40 that has been stopped, when the eco-run judging part 912 judges that the engine restart conditions are satisfied.

The totalizing part 914 is implemented by an eco-run judging process performed by the execution part 910b. The totalizing part 914 totalizes data used to calculate indicators representing eco-run control statuses. The indicators representing eco-run control statuses include a frequency at which the eco-run control stops the engine 40. A status where the eco-run control fails to stop the engine 40 represents the one where the engine 40 is not stopped because the user operation obtained by the obtaining part 911 does not satisfy the user requirements although the vehicle status obtained by the obtaining part 911 satisfies the vehicle requirements.

Hereinafter, concretely described are data totalized by the totalizing part 914 and indicators calculated by the calculation part 915 based on the data totalized by the totalizing part 914.

The totalizing part 914 totalizes data used to calculate an eco-run interruption indicator indicating a level that the eco-run control has been interrupted or an eco-run achievement indicator indicating a level that the eco-run control has been achieved. Here, an eco-run achievement percentage is a possible concrete example of the eco-run achievement indicator, and an eco-run interruption percentage is a possible concrete example of the eco-run interruption indicator. The mathematical formula 1 shown below represents a relation between the eco-run achievement percentage and the eco-run interruption percentage.

Eco-run interruption percentage=1−(eco-run achievement percentage) (Mathematical Formula 1)

The first possible example of the eco-run achievement indicator is an indicator indicating to what level idling stops have been achieved when the vehicle has been in a stopping status. As concrete examples of the indicator, the two types of the eco-run achievement percentage calculated by the mathematical formulae 2 shown below can be cited.

Eco-run achievement percentage=(idling stop time)/(vehicle stop time)

Eco-run achievement percentage=(number of idling stops)/(number of vehicle stops) (Mathematical Formulae 2)

Concretely, one type of the eco-run achievement percentage is calculated by dividing time duration when idling has been stopped (in other words, idling stop time) by time duration when vehicle has been stopping (in other words, vehicle stop time). The other type of the eco-run achievement percentage is calculated by dividing the number of times that idling has been stopped (in other words, number of idling stops) by the number of times that vehicle has stopped (in other words, number of vehicle stops). As a result, a level that the engine 40 has worked while the vehicle has not been running can be indicated.

Compared to the eco-run achievement percentage calculated using the number of vehicle stops, the eco-run achievement percentage calculated using vehicle stop time can precisely indicate a level that eco-run has been achieved even in a case where a short vehicle stop requiring no idling stop is repeated, for example, in traffic congestion. In addition, since the eco-run achievement percentage calculated using vehicle stop time changes in course of time, a chronological change of the eco-run achievement percentage can be indicated almost instantly. Contrarily, since the eco-run achievement percentage calculated using the number of vehicle stops changes associated with stops of the vehicle, a change of the eco-run achievement percentage can be indicated with respect to each vehicle stop. The totalizing part 914 calculates idling stop time and vehicle stop time of each vehicle stop, or the number of idling stops and the number of vehicle stops, based on a judgment by the eco-run judging part 912. Moreover, the totalizing part 914 may further adopt a configuration that totalizes data calculated per travel distance, trip, ignition, fueling, or predetermined time.

Moreover, the totalizing part 914 may adopt a configuration that excludes time duration from an ignition-on to the first run of the vehicle directly after the ignition-on from the idling stop time. An idling stop is not normally required during the time duration from an ignition-on to the first run of the vehicle directly after the ignition-on because a driver turns on the ignition of the vehicle when starting to drive the vehicle. As a result, an eco-run achievement level can be precisely indicated.

Another possible example of the eco-run achievement indicators is an indicator indicating a level that idling stops have been interrupted by user operations while the vehicle has been stopping. In other words, a second example of the eco-run achievement indicator is an indicator indicating a level that idling stops have been achieved by user operations while the vehicle has been stopping. As concrete examples of the eco-run achievement indicator, the two types of the eco-run achievement percentage calculated by the mathematical formulae 3 shown below can be cited.

Eco-run achievement percentage=(vehicle stop time−vehicle stop time that idling has not been stopped due to an unsatisfied user requirement)/(vehicle stop time)

Eco-run achievement percentage=(number of vehicle stops−number of vehicle stops that idling has not been stopped due to an unsatisfied user requirement)/(number of vehicle stops) (Mathematical Formulae 3)

The “vehicle stop time that idling has not been stopped due to an unsatisfied user requirement” means vehicle stop time that idling has not been stopped because the user requirements has not been satisfied due to a user operation although the vehicle requirements has been satisfied. The “number of vehicle stops that idling has not been stopped due to an unsatisfied user requirement” means the number of vehicle stops that idling has not been stopped because of the same reason mentioned above. As a result, a level that the eco-run control has been achieved by a user operation to the vehicle can be indicated.

A third possible example of the eco-run achievement indicator is an indicator indicating a level that idling stops have been achieved by a user operation in a case where the vehicle requirements have been satisfied. As concrete examples of the eco-run achievement indicator, the two types of the eco-run achievement percentage calculated by the mathematical formulae 4 shown below can be cited.

Eco-run achievement percentage=(idling stop achievement time)/(feasible idling stop time)

Eco-run achievement percentage=(number of achieved idling stops)/(number of feasible idling stops) (Mathematical Formulae 4)

The “feasible idling stop time” means time duration when the vehicle requirements have been satisfied. In other words, the “feasible idling stop time” means a sum of time duration when idling would have been stopped if the user requirements had been satisfied and time duration when idling has been actually stopped because the user requirements has been satisfied. The “idling stop achievement time” means time duration when idling has been stopped because both the vehicle requirements and the user requirements have been satisfied. The “number of feasible idling stops” means the number of vehicle stops that the vehicle requirements have been satisfied. In other words, the “number of feasible idling stops” means a sum of the number of times that idling would have been stopped if the user requirements had been satisfied and the number of stops that idling has been actually stopped because the user requirements has been satisfied. The “number of achieved idling stops” means the number of times that idling has been stopped because both the vehicle requirements and the user requirements have been satisfied. As a result, since the two types of the eco-run achievement percentage are independent of the vehicle requirements unable to be satisfied by a user operation, a level that eco-run control has been achieved by user operations can be indicated more clearly and more precisely.

Furthermore, the fourth possible example of the eco-run achievement indicator is an indicator indicating a level that idling stops have been achieved by a user operation at idling stop points. The idling stop point means a place where an idling stop can be achieved with an easy operation and an idling stop is appropriate. A possible concrete example of the idling stop point is a cross section where average vehicle stop time at a red light is longer than time duration required for satisfying the engine stop conditions. Contrarily, concrete possible examples of a place where an idling stop is not appropriate are in a tunnel, on an underground road, on a slope, and at a high accident location. The totalizing part 914 identifies a traveling course of the vehicle and an idling stop point on the traveling course of the vehicle, based on position information, date and time information, and weather information obtained from the navigation unit 50 because an idling stop point depends on date and time, season, weather, and traffic situation. As a concrete example, whether the user requirements are easily satisfied is different even at a same point of a road according to the date and time, season, and weather because, for example, electricity consumption by an air conditioner or other devices is different. Similarly, stop time duration and running speed of the vehicle in traffic congestion are different from the ones of good traffic even at the same point of the same road.

The totalizing part 914 totalizes data used to calculate ideal electricity achievement indicator indicating an ideal electricity consumption level achieved by the various electrical devices 80, based on the working information obtained by the obtaining part 911. An ideal electricity achievement percentage calculated by the mathematical formula 5 shown below is a possible concrete example of the ideal electricity achievement indicator. The ideal electricity achievement percentage is a percentage of an actual electricity consumption status to an ideal electricity consumption status of the various electrical devices 80 (hereinafter referred to as an ideal electrical device consumption status).

Ideal electricity achievement percentage=(actual electricity consumption status during an idling stop)/(ideal electrical device consumption status during an idling stop) (Mathematical Formula 5)

The totalizing part 914 identifies the ideal electrical device consumption status during an idling stop and the actual electricity consumption status during an idling stop, based on the working information obtained by the obtaining part 911. An ideal electricity consumption is an amount of electricity consumed ideally according to an environment outside the vehicle and electricity consumption that satisfies the user requirements.

Referring to FIG. 2B, the ideal electrical device consumption status is explained. FIG. 2B is a drawing showing examples of the ideal electrical device consumption status.

The drawing shown in FIG. 2B has an electrical device column and three level columns corresponding to first, second, and third levels. Information representing electrical devices included in the various electrical devices 80 is stored in the electrical device column. Information representing an amount of electricity consumed by each of the electrical devices represented by the information stored in the electrical device column is stored in the level columns. Concretely, the information stored in the level column corresponding to the first level represents an amount of electricity consumed by each of the electrical devices in the electrical device column in a case where each of the electrical devices transmits working information representing the first level.

The totalizing part 914 searches ideal electricity consumption information stored in advance, for each of the electrical devices, based on position information, date and time information, and weather information obtained by the obtaining part 911.

A concrete example is a case where position information obtained by the obtaining part 911 represents a point in a tunnel. In this case, the totalizing part 914 searches an amount of electricity belonging to the second level where an amount of electricity related to information representing a point in a tunnel is stored and determines the searched amount of electricity as ideal electricity consumption of an audio device. Due to loud noise in a tunnel, the audio device needs to consume a medium level of electricity to output sound at a medium volume. Electricity consumption in the second level is more than one in the first level, and electricity consumption in the third level is more than the one in the second level.

Similarly, in a case where the obtaining part 911 obtains date and time information representing daytime in spring, weather information representing a clear day, and position information representing a flatland at a mid-latitude, the totalizing part 914 determines an amount of electricity belonging to the first level where an amount of electricity is related to these information as ideal electricity consumption of the audio device. In daytime of a clear spring day, there is little need to use an air conditioner in a flatland at mid-latitude.

After identifying the ideal electricity consumption of each of the electrical devices, the totalizing part 914 totalizes the identified ideal electricity consumption. Moreover, after identifying actual electricity consumption of each of the electrical devices based on working status obtained by the obtaining part 911, the totalizing part 914 totalizes the identified actual electricity consumption.

Next, referring back to FIG. 3B, the configuration of the microcomputer 910 continues to be explained.

The calculation part 915 is implemented by a calculation process performed by the execution part 910b. The calculation part 915 calculates an indicator indicating an eco-run control status, using data totalized by the totalizing part 914. Concretely, the calculation part 915 calculates the level information indicative of an amount of occurrence of a state in which the engine 40 is stopped by the eco-run control. More concretely, the calculation part 915 calculates the eco-run achievement indicator and the eco-run interruption indicator mentioned above. Further concretely, the calculation part 915 calculates the eco-run achievement percentage which is a percentage of times that or time duration when the user operation obtained by the obtaining part 911 has satisfied the engine stop conditions in a case where a vehicle status obtained by the obtaining part 911 has satisfied the engine stop conditions, and also calculates the eco-run interruption percentage which is a percentage of times that or time duration when the user operation obtained by the obtaining part 911 has not satisfied the engine stop conditions in the same case as mentioned above. As a result, a percentage representing a level that the eco-run control has been interrupted by a user operation to the vehicle can be calculated. Therefore, a user of the vehicle, informed of this indicator, for example, can refrain from performing any operation interrupting the eco-run control from a start to an end of driving of the vehicle. The calculation part 915 calculates the ideal electricity achievement indicator mentioned above, using the data totalized by the totalizing part 914.

Moreover, the calculation part 915 calculates an ideal value of the indicator mentioned above. Concretely, the calculation part 915 determines an indicator value achieved by an excellent driver as an ideal value. Here, the excellent driver includes a driver skilled in fuel efficient driving. The eco-run achievement indicator is taken here as an example for an explanation. The eco-run achievement indicator achieved by an excellent driver is approximately 30 percent. However, one having ordinary skill in the art can change the ideal value of the eco-run achievement indicator and determine a more adequate value from an experiment because the ideal value of the eco-run achievement indicator varies according to designs of vehicles and driving skill levels of general drivers. The calculation part 915 may adopt a configuration that calculates the ideal value of the eco-run achievement indicator based on the vehicle requirements. Concretely, in a case where the vehicle has not been warmed up yet, there is a problem with the vehicle, the controller 100 or the controller 200 prohibits the eco-run control, the secondary battery 60 is degraded, or a predetermined interval has not completed after an idling stop, the calculation part 915 calculates the ideal value of the eco-run achievement indicator lower than the one in a case other than the above.

The informing controlling part 916 is implemented by an informing control process performed by the execution part 910b. The informing controlling part 916 controls the controller 100 so that the informing apparatus 70 provides information about a result of the eco-run control performed by the eco-run controlling part 913. Moreover, the informing controlling part 916 controls the controller 100 so that the informing apparatus 70 provides information about level information calculated by the calculation part 915. Furthermore, the informing controlling part 916 controls the controller 100 so that the informing apparatus 70 provides information that a user operation interrupts the eco-run control in a case where the eco-run judging part 912 judges that the user operation prevents the user requirements from being satisfied although the vehicle requirements are satisfied. In addition, the informing controlling part 916 commands the informing apparatus 70 to provide information about the user operation that the eco-run judging part 912 judges as preventing the user requirements from being satisfied. As a result, in a case where a user operation does not satisfy the engine stop conditions although a vehicle status satisfies the engine stop conditions, the informing controlling part 916 can provide control under which a user of the vehicle is informed that the user operation interrupts the eco-run control and also informed of the user operation preventing the engine stop conditions from being satisfied. Therefore, the informed user of the vehicle, for example, can refrain from the operation interrupting the eco-run control.

In addition, the informing controlling part 916 controls the controller 100 so that the informing apparatus 70 provides information about a difference between the level information calculated by the calculation part 915 and a calculated target value of the level information. A target value of an indicator is a value that a level represented by the level information calculated by the calculation part 915 is increased to exceed or decreased to fall below by changing an operation to the vehicle by a user. In this embodiment, the level target value is, but not limited to, an ideal value calculated by the calculation part 915. More concretely, the informing controlling part 916 commands the informing apparatus 70 to provide information about a difference between the vehicle of the eco-run achievement indicator and a target value of the eco-run achievement indicator. The informing controlling part 916 may adopt a configuration that provides information about a difference between the eco-run interruption indicator and a target value of the eco-run interruption indicator. Moreover, the informing controlling part 916 commands the informing apparatus 70 to provide information about a difference between the ideal electricity achievement indicator and a target value of the ideal electricity achievement indicator.

Next described is a timing of when the informing controlling part 916 controls the informing apparatus 70. The informing controlling part 916 controls the informing apparatus 70 so that the informing apparatus 70 informs the user of the vehicle of an indicator calculated by the calculation part 915 using the number of vehicle stops or the number of idling stops when a vehicle status obtained by the obtaining part 911 changes from a running status to a stopping status. As a result, the indicator changing according to a stop of the vehicle can be provided almost instantly. Moreover, the informing controlling part 916 controls the informing apparatus 70 so that the informing apparatus 70 provides information, while the vehicle is stopping, about an indicator calculated by the calculation part 915 using vehicle stop time or idling stop time. As a result, chronological change of the indicator can be provided almost instantly. Moreover, a percentage of a user operation to the vehicle that has prevented the engine stop conditions from being satisfied can be provided while the vehicle is in a stopping status where the user of the vehicle can perform an operation to satisfy the engine stop conditions. Therefore, the user of the vehicle can refrain from the operation interrupting the eco-run control immediately after being informed.

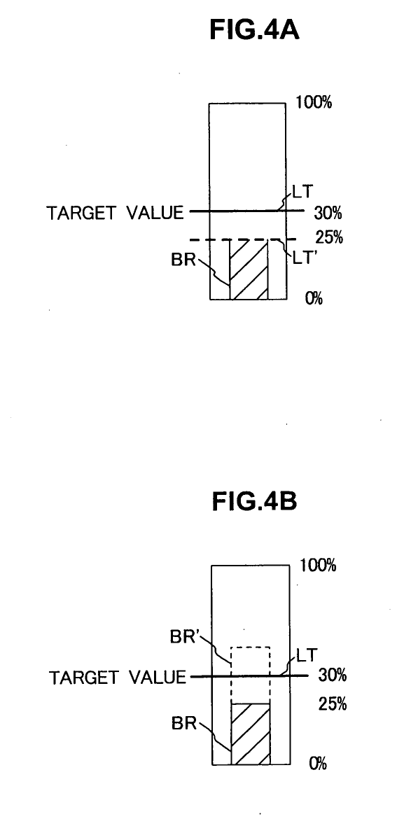

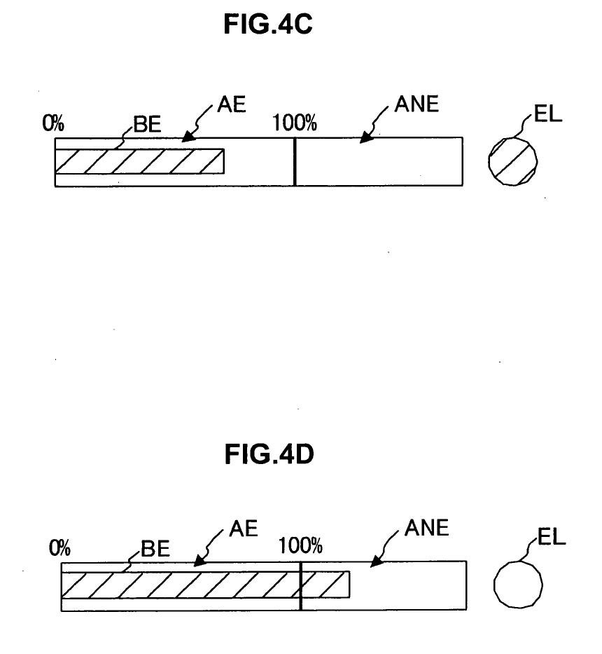

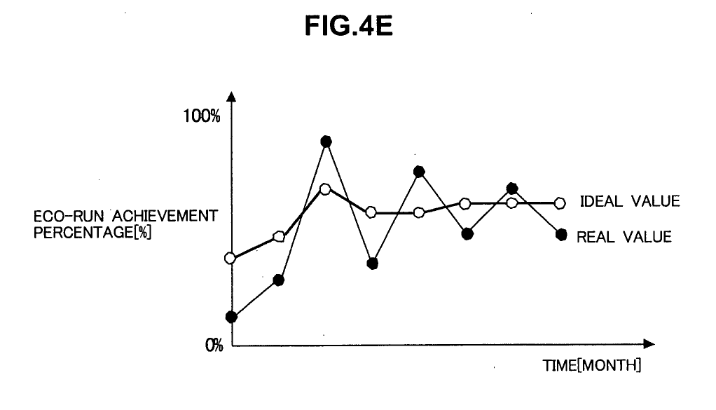

Referring to FIGS. 4A to 4E, described is informing styles in which the informing apparatus 70 under control of the informing controlling part 916 informs the user of the vehicle. FIG. 4A shows an example displayed on the informing apparatus 70.

As shown in FIG. 4A, the informing apparatus 70 informs a user of the vehicle of the eco-run achievement percentage, using, for example, a meter BR like a vertical bar graph. FIG. 4A shows the meter BR representing the eco-run achievement percentage in association with the least eco-run achievement percentage, 0%, and the largest eco-run achievement percentage, 100%. In addition, the informing apparatus 70 informs the user of the vehicle of a target value of the eco-run achievement percentage, for example, with a horizontal line LT. As a result, the informing apparatus 70 can be controlled to provide information about a difference between a calculated eco-run achievement percentage and the target value of the eco-run achievement percentage. Therefore, the user of the vehicle can refrain from an operation interrupting the eco-run control to reduce the difference between the actual percentage and the target value. Moreover, the informing apparatus 70 also informs the user of the vehicle of the target value of before a change, of the eco-run achievement percentage. Concretely, in FIG. 4A, the informing apparatus 70 shows an indicator target value of before a change with a dashed line LT′ and the indicator target value of after the change with the solid line LT. As a result, the informing apparatus 70 can inform the user of the vehicle of the change of the calculated target value.

Moreover, as shown in FIG. 4B, the informing apparatus 70 may adopt a configuration where the informing apparatus 70 also informs the user of the vehicle of the eco-run achievement percentage of before a change. Concretely, the informing apparatus 70 shows an indicator of before a change with a dashed meter BR′ and the indicator of after the change with the solid meter BR. As a result, the informing apparatus 70 can inform the user of the vehicle of the change of the calculated indicator value.

Drawings shown in FIG. 4A and FIG. 4B are displayed by the informing apparatus 70 while the vehicle is stopping. As a result, since the eco-run achievement percentage calculated using vehicle stop time changes according to a change in vehicle stop time, the informing apparatus 70 can inform the user of the vehicle of the change in the percentage almost instantly. Moreover, since the eco-run achievement percentage calculated using the number of vehicle stops changes according to a change in the number of vehicle stops, the informing apparatus 70 can inform the user of the vehicle of the change in the percentage at every stop of the vehicle.

On the other hand, as shown in FIG. 4C and FIG. 4D, while the vehicle is running, the informing apparatus 70 informs the user of the vehicle of whether the user drives the vehicle in an economical way that reduces fuel consumption (hereinafter referred to as eco-driving) with an eco lamp EL lit, for example. In addition, the informing apparatus 70 informs the user of the vehicle of an eco-driving status level using, for example, a meter BE like a horizontal bar graph. The eco-driving status level is an indicator indicating to which level eco-driving is satisfactorily achieved (hereinafter referred to as eco-driving status level). The informing apparatus 70 displays an eco-bar BE in association with an eco-driving range AE and a non-eco driving range ANE. The eco-driving range AE is a range representing that the user implements eco-driving in a case where a tip end of the eco-bar BE is in the range. The non-eco driving range ANE is a range representing that the user implements driving other than eco-driving (non-eco driving) in a case where a tip end of the eco-bar BE is in the range. In other words, with a distance from the tip end of the eco-bar BE to a boundary between the eco-driving range AE and the non-eco driving range ANE, the informing apparatus 70 shows an operation allowance, for example which represents to what amount an acceleration pedal operation can be increased while the eco-driving is maintained.

The calculation part 915 calculates eco-driving status level using following the mathematical formula 6. Concretely, the calculation part 915 calculates the eco-driving status level using an accelerator opening degree obtained by the obtaining part 911 and an upper threshold defined based on a vehicle speed obtained by the obtaining part 911. The upper threshold is an upper limit of an accelerator opening degree allowing for eco-driving in a case where a vehicle runs at a predetermined speed and is stored in the calculation part 915 in advance.

Eco-driving status level=(present accelerator opening degree)/(upper threshold)×100 (Mathematical Formula 6)

The informing apparatus 70 displays the eco-driving status level shown in FIG. 4C or FIG. 4D while the vehicle is running and the eco-run achievement percentage shown in FIG. 4A or FIG. 4B while the vehicle is stopping. However, not limited to the mentioned above, the informing apparatus 70 may adopt a configuration that shows both the eco-driving status level and the eco-run achievement percentage at the same time. In this configuration, the informing apparatus 70 may adopt a configuration that shows the eco-driving status level brighter than the eco-run achievement percentage while the vehicle is running and the eco-run achievement percentage brighter than the eco-driving status level while the vehicle is stopping. As a result, a changeover of the displayed indicators can be easily controlled and stress on the user of the vehicle, resulting from changeover of the displayed indicators, can be reduced.

As shown in FIG. 4E, the informing apparatus 70 displays a change in the eco-run achievement percentage in the course of time and a change in the target value of the eco-run achievement percentage in the course of time, in association with the course of time. Concretely, an abscissa axis represents date and time, and an ordinate axis represents the eco-run achievement percentage in a predetermined period. The eco-run achievement percentage for a predetermined period may be, for example, the average, the lowest value or the highest value of the eco-run achievement percentage or any eco-run achievement percentage in the predetermined period, and the target value of the eco-run achievement percentage for a predetermined period also may be, for example, the average, the lowest value or the highest target value of the eco-run achievement percentage or any target value of the eco-run achievement percentage in the predetermined period. In this embodiment, it is explained that the informing apparatus 70 chronologically displays the eco-run achievement percentage per month. However, not limited to that, the informing apparatus 70 may adopt, for example, a configuration that displays the eco-run achievement percentage per predetermined travel distance, trip, ignition, fueling, or predetermined time. As a result, the informing apparatus 70 can display a change in acquired eco-driving skill of a user in the course of time.

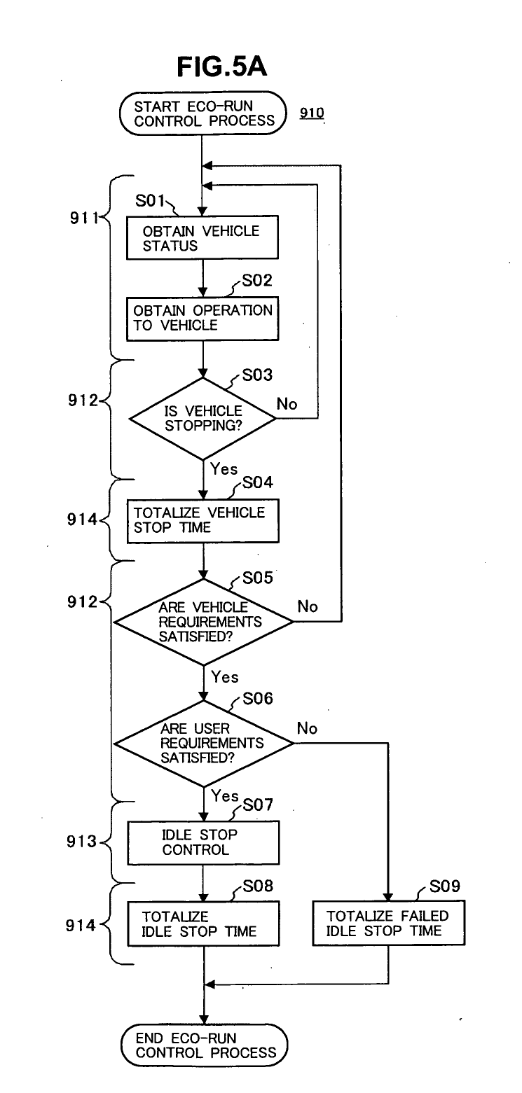

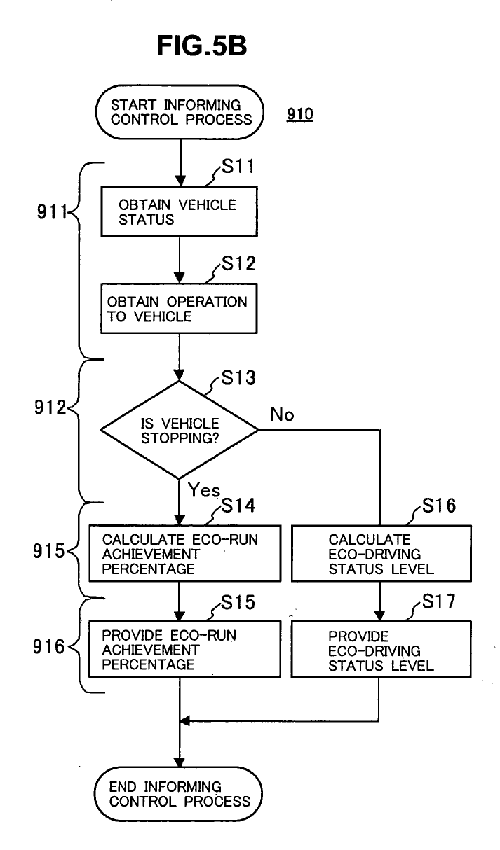

Referring to FIG. 5A, a software process performed by the microcomputer 910 is explained. The software process performed by the microcomputer 910 includes an eco-run control process that controls eco-run execution and informing control process that controls informing execution. FIG. 5A is a flowchart showing an example of the eco-run control process performed by the microcomputer 910. The microcomputer 910 periodically performs the eco-run control process.

First, the microcomputer 910 obtains a vehicle status and a status of a user operation from the detector 10 and other devices (a step S01 and a step S02). Next, the microcomputer 910 judges whether the vehicle is stopping based on the vehicle status, the status of a user operation, or both (a step S03). In a case where the microcomputer 910 judges that the vehicle is stopping, the microcomputer 910 implements a process of a step S04. In a case where the microcomputer 910 judges that the vehicle is not stopping, the microcomputer 910 goes back to the step S01 and repeats the process mentioned above.

In the step S03, in a case where the microcomputer 910 judges that the vehicle is stopping, the microcomputer 910 totalizes vehicle stop time used to calculate an eco-run achievement percentage, for example, using the mathematical formula 3 (the step S04). Next, the microcomputer 910 judges whether the vehicle requirements are satisfied based on the vehicle status obtained in the step S01 (a step S05). In a case where the microcomputer 910 judges that the vehicle requirements are satisfied, the microcomputer 910 implements a process of a step S06. In a case where the microcomputer 910 judges that the vehicle requirements are not satisfied, the microcomputer 910 goes back to the step S01 and repeats the process mentioned above.

In the step S05, in a case where the microcomputer 910 judges that the vehicle requirements are satisfied, the microcomputer 910 judges whether the user requirements are satisfied based on a user operation obtained in the step S02 (a step S06). In a case where the microcomputer 910 judges that the user requirements are satisfied, the microcomputer 910 implements a process of a step S07. In a case where the microcomputer 910 judges that the user requirements are not satisfied, the microcomputer 910 implements a process of a step S09.

In a case where the microcomputer 910 judges the user requirements are satisfied in the step S06, the microcomputer 910 controls the engine 40 so that the engine 40 stops idling (idling stop control) (the step S07). Next, the microcomputer 910 totalizes idling stop time used to calculate an eco-run achievement percentage, for example, using the mathematical formulae 2 or the mathematical formulae 4 (a step S08). And then, the microcomputer 910 ends execution of the eco-run control process.

In a case where the microcomputer 910 judges that the user requirements are not satisfied in the step S06, the microcomputer 910 totalizes, for example, vehicle stop time when idling has not been stopped due to an unsatisfied user requirement (vehicle stop time when the engine has failed to stop idling due to an unsatisfied user requirement) (a step S09). And then, the microcomputer 910 ends the execution of the eco-run control process.

In the FIG. 5A, the process in the step S01 and step S02 is equivalent to an example of an obtaining process for implementing the obtaining part 911, and the process in the step S03, step S05, and step S06 is equivalent to an example of the eco-run judging process for implementing the eco-run judging part 912. The process in the step S04, step S08 and step S09 is equivalent to an example of a totalizing process for implementing the totalizing part 914, and the process in the step S07 is equivalent to an example of an eco-run control process for implementing the eco-run controlling part 913.

Referring to FIG. 5B, the informing control process performed by the microcomputer 910 is explained. FIG. 5B is a flowchart showing an example of the informing control process performed by the microcomputer 910. The microcomputer 910 periodically performs the informing control process.

First, the microcomputer 910 performs a process similar to the process from the step S01 to the step S03 shown in FIG. 5A (from a step S11 to a step S13). In the step 13, in a case where the microcomputer 910 judges that the vehicle is stopping, the microcomputer 910 calculates an eco-run achievement percentage using data totalized in the step S04, step S08 and step S09 shown in FIG. 5A (a step S14). Next, the microcomputer 910 controls the informing apparatus 70 so that the informing apparatus 70 provides information about the calculated eco-run achievement percentage (a step S15). And then, the microcomputer 910 ends the execution of the informing control process.

In the step S13, in a case where the microcomputer 910 judges that the vehicle is running (in other words, the vehicle is not stopping), the microcomputer 910 calculates an eco-driving status level using data obtained in the step S01 and step S02 shown in FIG. 5A and upper threshold data stored in advance (a step S16). Next, the microcomputer 910 controls the informing apparatus 70 so that the informing apparatus 70 provides information about the calculated an eco-driving status level (a step S17). And then, the microcomputer 910 ends the execution of the informing control process.

In the FIG. 5B, the process in the step S11 and step S12 is equivalent to an example of the obtaining process for implementing the obtaining part 911 and the process in the step S13 is equivalent to an example of the eco-run judging process for implementing the eco-run judging part 912. The process in the step S14 and step S16 is equivalent to an example of a calculating process for implementing the calculation part 915, and the process in the step S15 and step S17 is equivalent to an example of the informing control process for implementing the informing controlling part 916.

A vehicle status monitoring method can be implemented using the vehicle status monitoring apparatus 900.

A program executed by the vehicle status monitoring apparatus 900 can be distributed after restored in a memory medium such as a magnetic disk, an optical disk, a semiconductor memory, or other types of media or provided by transmission via a network.

Moreover, a part or all of functions implemented in a software process performed by the vehicle status monitoring apparatus 900 may be implemented using a hardware circuit. Contrarily, a part or all of the functions implemented by the vehicle status monitoring apparatus 900 using a hardware circuit may be implemented in a software process.

While the invention has been shown and described in detail, the foregoing description is in all aspects illustrative and not restrictive. It is therefore understood that numerous other modifications and variations can be devised without departing from the scope of the invention.

What is claimed is:

1. A vehicle status monitoring apparatus for monitoring a vehicle status in which it is possible to control an engine to stop the engine in a case where the vehicle status satisfies first conditions and a user operation satisfies second conditions, the apparatus comprising:
a first judging part that judges whether the vehicle status satisfies the first conditions;
a second judging part that judges whether the user operation satisfies the second conditions;
a calculation part that calculates level information indicative of an amount of occurrence of a state in which the user operation does not satisfy the second conditions while the vehicle status satisfies the first conditions; and
a controller that controls an informing apparatus to inform a user of the level information.

2. The vehicle status monitoring apparatus according to claim 1, wherein the level information comprises
a percentage of number of times that the user operation does not satisfy the second conditions while the vehicle status satisfies the first conditions.

3. The vehicle status monitoring apparatus according to claim 1, wherein the level information comprises
a percentage of time duration when the user operation does not satisfy the second conditions while the vehicle status satisfies the first conditions.

4. The vehicle status monitoring apparatus according to claim 1, wherein
the controller controls the informing apparatus so that the informing apparatus provides the level information while the vehicle is stopping.

5. The vehicle status monitoring apparatus according to claim 4, wherein
the first conditions include a condition that the vehicle is stopping.

6. The vehicle status monitoring apparatus according to claim 4, wherein
the controller controls the informing apparatus so that the informing apparatus provides information showing a level of fuel efficient driving while the vehicle is running.

7. The vehicle status monitoring apparatus according to claim 1, wherein
the controller controls the informing apparatus so that the informing apparatus provides information about a difference between the level information and a target value of the level information.

8. The vehicle status monitoring apparatus according to claim 1, further comprising
the informing apparatus that informs the user of the level information.

9. An engine control system that is capable of controlling an engine to stop the engine, the system comprising:
a first judging part that judges whether a vehicle status satisfies first conditions;
a second judging part that judges whether a user operation satisfies second conditions;
a first controller that stops the engine in a case where the vehicle status satisfies the first conditions and the user operation satisfies the second conditions;
a calculation part that calculates level information indicative of an amount of occurrence of a state in which the user operation does not satisfy the second conditions while the vehicle status satisfies the first conditions; and
a second controller that controls an informing apparatus to inform a user of the level information.

10. The engine control system according to claim 9, further comprising
the informing apparatus that informs the user of the level information.

11. A vehicle status monitoring method of monitoring a vehicle status in which it is possible to control an engine to stop the engine in a case where a vehicle status satisfies first conditions and a user operation satisfies second conditions, the method comprising the steps of:
judging whether the vehicle status satisfies the first conditions;
judging whether the user operation satisfies the second conditions;
calculating level information indicative of an amount of occurrence of a state in which the user operation does not satisfy the second conditions while the vehicle status satisfies the first conditions; and
controlling an informing apparatus to inform a user of the level information.

12. The method according to claim 11, wherein the level information comprises
a percentage of number of times that the user operation does not satisfy the second conditions while the vehicle status satisfies the first conditions.

13. The method according to claim 11, wherein the level information comprises
a percentage of time duration when the user operation does not satisfy the second conditions while the vehicle status satisfies the first conditions.

14. The method according to claim 11, wherein
the controlling step controls the informing apparatus so that the informing apparatus provides the level information while the vehicle is stopping.

15. The method according to claim 14, wherein
the first conditions include a condition that the vehicle is stopping.

16. The method according to claim 14, wherein
the controlling step controls the informing apparatus so that the informing apparatus provides information showing a level of fuel efficient driving while the vehicle is running.

17. The method according to claim 11, wherein
the controlling step controls the informing apparatus so that the informing apparatus provides information about a difference between the level information and a target value of the level information.
